(19) United States
(12) Patent Application Publication
(10) Pub. No.: US 2015/0153807 A1
(43) Pub. Date: Jun. 4, 2015

(54) METHOD FOR REDUCING POWER CONSUMPTION AND SENSOR MANAGEMENT SYSTEM FOR THE SAME

(71) Applicant: PEGATRON CORPORATON, Taipei City (TW)

(72) Inventors: Wei-Hua HAO, Taipei City (TW); Nigel HSIUNG, Taipei City (TW)

(21) Appl. No.: 14/555,315

(22) Filed: Nov. 26, 2014

(30) Foreign Application Priority Data
Nov. 29, 2013 (TW) 102143820

(51) Int. Cl. G06F 1/32

(52) U.S. Cl. CPC G06F 1/325; G06F 1/3296

(57) ABSTRACT

A method of reducing power consumption of an electronic device, the electronic device including a plurality of sensors, the method comprising the steps of: receiving sensed information from the sensors within a predetermined time period; judging whether the electronic device is under a stationary state within a predetermined time period according to a data variation of the sensed information received within the predetermined time period; and controlling a portion of the sensors to enter into a sleeping state or a low-power consumption state when the electronic device is under the stationary state within the predetermined time period.

### BACKGROUND

1. Technology Field

The disclosure relates to a method of reducing the power consumption of an electronic device and, in particular, to a method of reducing power consumption by managing the sensing behavior of the sensors of an electronic device.

2. Related Art

Along with the rapid development of technology, a handheld electronic device, such as a smartphone, is often equipped with sensors such as gravity sensors, gyroscopes and electronic compasses to sense the movement or the placed state of the handheld electronic device, and performs a corresponding function according to the different states of the handheld electronic device, such as changing the direction of displaying a picture.

Most of the time, the handheld electronic device of a user is under a stationary state. However, under such state, the sensors of a modern handheld electronic device do not change their sensing behavior or perform any power-saving action. In other words, even after the handheld electronic device remains stationary for a long time, the sampling rates of the sensors are not reduced and the sensors remain under their normal sensing state. Therefore, the power consumed by the sensors is the same regardless of whether the electronic device is under a stationary state or not. Since a handheld electronic device is under the stationary state most of the time, and it is not necessary to perform certain control functions via sensing the direction, the operation time of the handheld electronic device can be extended through the management of the sensor behaviors to reduce power consumption after the handheld electronic device remains stationary for a period of time.

### SUMMARY OF THE INVENTION

The objective of the invention is to provide a method of reducing power consumption suitable for an electronic device.

Another objective of the invention is to provide a sensor management system to perform the method of reducing power consumption.

To achieve the above objective, the method of reducing power consumption of the invention is for an electronic device, wherein the electronic device includes a plurality of sensors. The method of reducing power consumption includes the steps of: receiving sensed information from the sensors within a predetermined time period; judging whether the electronic device is under a stationary state within a predetermined time period according to whether a data variation of the sensed information received within the predetermined time period exceeds a preset error value; and controlling a portion of the sensors to enter into a sleeping state or a low-power consumption state when the electronic device is under the stationary state within the predetermined time period.

According to another embodiment of the invention, the method of reducing power consumption includes the steps of: receiving sensed information from the sensors within a predetermined time period; judging whether the electronic device is under a stationary state within a predetermined time period according to whether a data variation of the sensed information received within the predetermined time period exceeds a preset error value; and reducing the sampling rate of at least one of the sensors when the electronic device is under the stationary state within the predetermined time period.

The sensor management system of the invention is for an electronic device, the electronic device including a plurality of sensors. The sensor management system includes a receiving module, a judging module and a state control module. The receiving module is for receiving sensed information from the sensors. The judging module is for judging whether the electronic device is under a stationary state within a predetermined time period according to whether a data variation of the sensed information received within the predetermined time period exceeds a preset error value. The state control module is for controlling a portion of the sensors to enter into a sleeping state or a low-power consumption state when the electronic device is under the stationary state within the predetermined time period.

According to another embodiment of the invention, the sensor management system includes a receiving module, a judging module and a sampling rate setting module. The receiving module is for receiving sensed information from the sensors. The judging module is for judging whether the electronic device is under a stationary state within a predetermined time period according to whether a data variation of the sensed information received within the predetermined time period exceeds a preset error value. The sampling rate setting module for reducing the sampling rate of at least one of the sensors when the electronic device is under the stationary state within the predetermined time period.

### BRIEF DESCRIPTION OF THE DRAWINGS

FIG. 1 is a schematic diagram showing the application of the sensor management system in an electronic device according to an embodiment of the invention.

FIG. 2 is a system diagram of the sensor management system of an embodiment of the invention.

FIG. 3 is a schematic diagram showing the sensor management system implemented in another electronic device.

FIG. 4 is a flowchart showing the process for the sensors to enter into the power saving state from the normal state.

FIG. 5 is a flowchart showing how the sensors are restored from the power-saving state back to the normal state.

### DETAILED DESCRIPTION OF THE EMBODIMENT

The present invention will be apparent from the following detailed description, which proceeds with reference to the accompanying drawings, wherein the same references relate to the same elements.

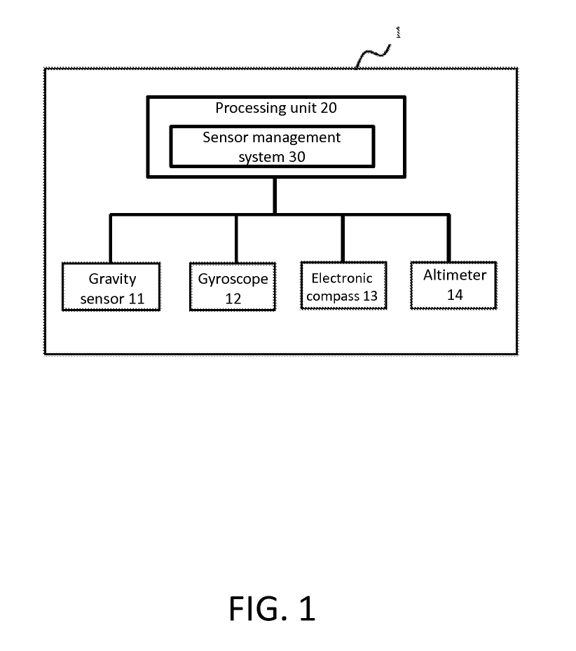

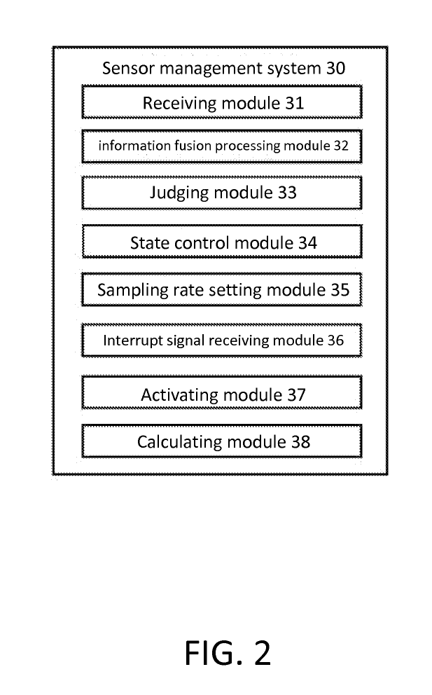

Please refer to FIG. 1 and FIG. 2, wherein FIG. 1 is a schematic diagram showing the application of the sensor management system in an electronic device according to an embodiment of the invention. FIG. 2 is a system diagram of the sensor management system of an embodiment of the invention.

As shown in FIG. 1, the sensor management system 30 according to an embodiment of the invention is used in an electronic device 1. In the present embodiment, the electronic device 1 includes a plurality of sensors, such as a gravity sensor 11, a gyroscope 12, an electronic compass 13 and an altimeter 14, and a processing unit 20. The sensors may sense and obtain sensed information related to the direction or movement of the electronic device 1 according to a preset sampling rate, such as once per 0.2 seconds. Since the sensors mentioned here are conventional components, and the sensing method and the information sensed are also known to persons having ordinary skill in the art, relevant descriptions are omitted here for concise purpose. It is also noteworthy that the sensors mentioned above are for exemplary purposes only, and the electronic device 1 may include other sensors related to the sensing of the motion or direction of the electronic device. In the embodiment of the invention, the electronic device 1 is a smart phone. However, the invention is not limited therein.

As shown in FIG. 2, in one embodiment of the invention, the sensor management system 30 includes a receiving module 31, an information fusion processing module 32, a judging module 33, a state control module 34, a sampling rate setting module 35, an interrupt signal receiving module 36, an activating module 37 and a calculating module 38. In the embodiment of the invention, the modules mentioned above are implemented by software programs. However, the invention is not limited therein. In practical applications, the architecture showed in FIG. 1 may be an electronic device 1 installed with Android operating system. The sensor management system 30 of the embodiment may be included in the Hardware Abstraction Layer (HAL) and executed by the processing unit 20.

The receiving module 31 is for receiving the sensed information from the sensors 10 at a specific time interval, such as 0.2 seconds.

The information fusion processing module 32 is for performing a sensor fusion processing to the sensed information after obtaining data relevant to the sensed information. Since sensor fusion is known in the art and is not the key point of the invention, the details are omitted here for concise purpose.

The judging module 33 judges whether the electronic device 1 is under a stationary state within a predetermined time period by judging whether the data variation of the sensed information sensed by the sensors 10 within the predetermined time period, such as 30 seconds, exceeds a preset error value. For example, in the predetermined time period, if the acceleration information on the Y axis obtained by the gravity sensor for the first time is 1g (gravity) and becomes 2g for the second time, it is judged that the electronic device 1 has a movement on the Y axis since the variation is too large. The preset error value may be determined by the system developer, and may be set that it is judged to be under the stationary state when the variation is zero, which means data on the X, Y and Z axes are all the same within the predetermined time period.

The state control module 34 is for controlling a portion of the sensors to enter into a sleeping state or a low-power consumption state when the electronic device 1 is under the stationary state within the predetermined time period. For example, assuming that the current supplied to the gyroscope 12 is 20 mA under the normal state, when the electronic device 1 remains unmoved within the predetermined time period, the state control module 34 adjusts the current supplied to the gyroscope 12 from 20 mA to 20 μA, so that the gyroscope 12 enters from the normal state into the low-power consumption state or even the sleeping state.

In the embodiment of the invention, the sampling rate setting module 35 is for reducing the sampling rate of the sensors that do not enter into the sleep state when the electronic device 1 is determined to be under the stationary state for the predetermined time period. For example, when the electronic device 1 has no movement within the predetermined time period, the sampling rate setting module 35 controls the gravity sensor 11, the gyroscope 12, the electronic compass 13 and the altimeter 14 to reduce their sampling rates from once per 0.2 second to once per 1 second.

The interrupt signal receiving module 36 is for receiving the interrupt signals from the sensors that do not enter into the sleeping state (such as the gravity sensor 11) after a portion of the sensors have entered into the sleeping state of the low-power consumption state (such as the gyroscope 12 or the altimeter 14).

In the embodiment of the invention, the activating module 37 is for restoring the sensors entered into the sleeping state or the low-power consumption state back to the normal state according to the interrupt signal, and restoring the reduced sampling rate of the sensors back to the original sampling rate.

In the embodiment of the invention, the calculating module 38 is for generating the predicted sensed information using the sensed information when the receiving module 31 receives the sensed information from the sensors after the sampling rate is reduced. In the embodiment, the calculating module 38 obtains the predicted sensed information using the Kalman filter algorithm after obtained the sensed information. However, the invention is not limited therein. The predicted sensed information may be generated by linear interpolation. The Kalman filter algorithm is known by those having ordinary skill in the art; therefore its details are omitted here for concise purpose.

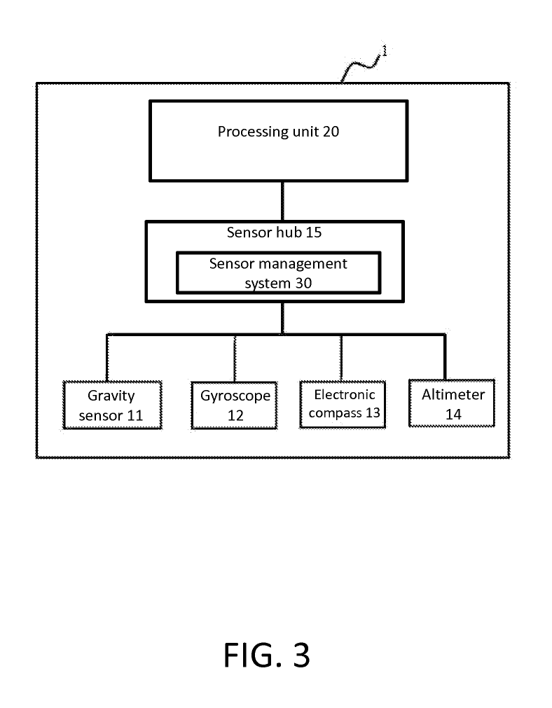

Referring to FIG. 3, which is a schematic diagram showing the sensor management system implemented in another electronic device. As shown in FIG. 3, the sensors of the electronic device 1 may further include a sensor hub 15. The sensor hub 15 can replace the processing unit 20 mentioned above to execute the sensor management system 30 of the embodiment. More specifically, this can be implemented in an electronic device 1 installed with Windows operating system. Here the sensor management system 30 can be included in and executed by the sensor hub 15.

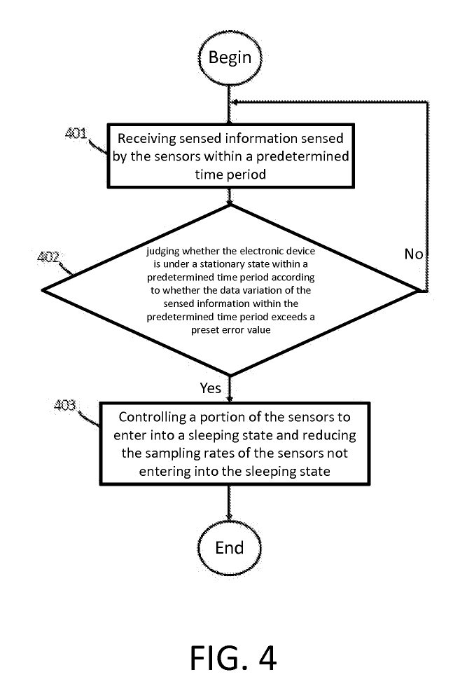

Please refer to FIG. 4 together with FIG. 1 and FIG. 2. FIG. 4 is a flowchart showing the process for the sensors to enter into the power saving state from the normal state. The method of reducing power consumption of an embodiment of the invention will be described hereinbelow with reference to FIG. 1 and FIG. 2. Note that although the electronic device 1 is used as an example, the method of reducing power consumption disclosed by the invention is not limited by using the electronic device 1 mentioned above.

First, step 401 is performed: receiving sensed information sensed by the sensors within a predetermined time period.

Generally speaking, after the electronic device 1 is shipped from the factory, the built-in gravity sensor 11, the gyroscope 12, the electronic compass 13 and the altimeter 14 perform sensing using their respective sampling rates, and report the sensed information to the sensor management system 30 after sensed relevant sensed information. The receiving module 31 is for receiving the sensed information from the sensors 10 at a specific time interval. For example, assuming the sampling rate of the sensor is once per 0.2 second, the receiving module 31 receives sensed information every 0.2 second. In the embodiment of the invention, the predetermined time period is 30 seconds, but the invention is not limited therein.

Performing step 402: judging whether the electronic device is under a stationary state within a predetermined time period according to whether the data variation of the sensed information within the predetermined time period exceeds a preset error value.

The receiving module 31 receives several sets of sensed information from the sensors before and after the predetermined time period. At this moment the judging module 33 judges whether the electronic device 1 is under the stationary state within the predetermined time period according to whether the data of the sensed information obtained within the predetermined time period are the same to or within the scope of the preset error value, that is the amount of data variation. For example, assuming that the receiving module 31 receives the sensed information every 0.2 second, then within a predetermined time period of 30 seconds, the receiving module 31 would receive 150 sets of sensed information. The judging module 33 judges whether the electronic device 1 is under the stationary state within the predetermined time period according to the 150 sets of sensed information received.

Step 403: controlling a portion of the sensors to enter into a sleeping state and reducing the sampling rates of the sensors not entering into the sleeping state.

In an embodiment of the invention, once the electronic device 1 is under the stationary state within the predetermined time period, the state control module 34 controls a portion of the sensors to enter into the sleeping state, and the sampling rate setting module 35 changes the setting of the sampling rates so that the sampling rates of the sensors not entering into the sleeping state are reduced. For example, when the judging module 33 judges that the electronic device 1 has no movement within the predetermined time period, the state control module 34 controls the gyroscope 12 and the altimeter 14 to enter into the sleeping state and reduces the sampling rates of the gravity sensor 11 and the electronic compass 13 from once per 0.2 second to once per 1 second. The power consumption of the sensors thus can be reduced significantly.

Note that it is not necessary to simultaneously implement the two methods mentioned above, that is, to control the sensors to enter into the sleeping state/low-power consumption state and to reducing the sampling rates of the sensors. The technical effect of reducing power consumption can be achieved by performing one of them. Moreover, when the sensor management system of the embodiment is implemented in the hardware architecture shown in FIG. 3, the sensor hub 15 can be controlled to enter into the sleeping or low-power consumption state as long as one of the sensors is still under the normal state. To sum up, the two methods can be performed alone or in parallel to make all or a portion of the sensors enter into the sleeping state/low-power consumption state, or to reduce the sampling rates, or to make a portion of the sensors enter into the sleeping state, a portion of the sensors enter into the low-power consumption state, and reduce the sampling rates of a portion of the sensors.

Furthermore, when the sampling rates of the sensors are reduced, since the number of the samples of the sensed information obtained within a fixed time are reduced, the data samples reported by the sensor management system 30 to the system application after performing fusion calculations to the sensed information is also reduced. Therefore, to not reducing the data amount received by the system application, in the embodiment of the invention, after the receiving module 31 receives the sensed information again, the calculation module 38 generates the predicted sensed information using the Kalman filter algorithm according to this sensed information to report the predicted sensed information to the system application before the next sensed information is sensed.

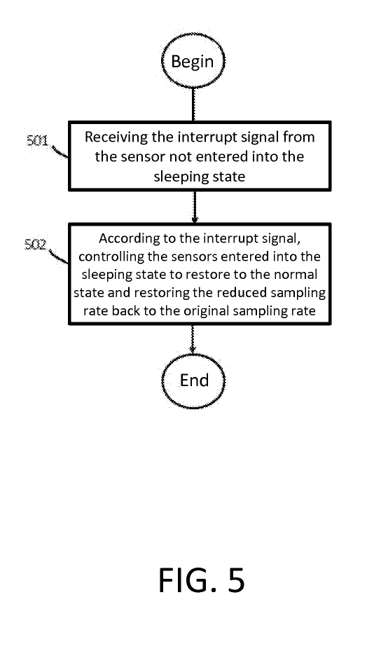

Lastly, please refer to FIG. 5 together with FIG. 1 and FIG. 2. FIG. 5 is a flowchart showing how the sensors are restored from the power-saving state back to the normal state.

After the sensors are controlled to enter into the sleeping state, the non-slept sensors, such as the gravity sensor 11, keeps sensing the movement of the electronic device 1. Once the variation of data sensed by the non-slept sensor exceeds a certain range, the sensor can issue an interrupt signal via the setting of hardware interrupt techniques. The interrupt signal receiving module receives this interrupt signal, which is step 501.

Then, after the interrupt signal receiving module receives the interrupt signal, the activating module 37 controls the sensors entered into the sleeping state to restore to the normal state according to the interrupt signal, and restore the reduced sampling rate back to the original sampling rate, which is step 502.

Note that the method of reducing power consumption of the intention is not limited to the sequence of the steps mentioned above. The sequence of the steps mentioned above can be changed as long as the objective of the invention can be achieved.

To sum up, the method of reducing power consumption of the invention reduces the power consumption of the sensors through managing the sensing behaviors such as reducing the sampling rates of the sensors or making the sensors enter into a low-power consumption state or even a sleeping state when the electronic device has no movement for a period of time. Except for reducing the power consumption of the sensors themselves, the number of executions of sensor fusions to the sensed information can be reduced, which can reduce the power consumption of the electronic device significantly.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of reducing power consumption of an electronic device, the electronic device including a plurality of sensors, the method comprising the steps of:
receiving sensed information from the sensors within a predetermined time period;
judging whether the electronic device is under a stationary state within the predetermined time period according to whether a data variation of the sensed information received within the predetermined time period exceeds a preset error value; and
if yes, controlling a portion of the sensors to enter into a sleeping state or a low-power consumption state.

2. The method of reducing power consumption according to claim 1, wherein when the electronic device is under the stationary state within the predetermined time period, the method further comprises the step of:
reducing a sampling rate of the sensors not entered into the sleeping state or the low-power consumption state.

3. The method of reducing power consumption according to claim 2, further comprising the steps of:
receiving an interrupt signal from the sensor not entered into the sleeping state; and
restoring the sensors entered into the sleeping state or the low-power consumption state to a normal state, and restoring the sampling rate of the sensors which sampling rate was reduced.

4. The method of reducing power consumption according to claim 2, wherein after reducing the sampling rate, the method further comprises the step of:
receiving the sensed information from the sensors not entered into the sleeping state.

5. The method of reducing power consumption according to claim 4, wherein the sensors further comprises a sensor hub.

6. A method of reducing power consumption of an electronic device, the electronic device including a plurality of sensors, the method comprising the steps of:
receiving sensed information from the sensors within a predetermined time period;
judging whether the electronic device is under a stationary state within a predetermined time period according to whether a data variation of the sensed information received within the predetermined time period exceeds a preset error value; and
if yes, reducing the sampling rate of at least one of the sensors.

7. A sensor management system for an electronic device, the electronic device including a plurality of sensors, the sensor management system comprising:
a receiving module for receiving sensed information from the sensors;
a judging module for judging whether the electronic device is under a stationary state within a predetermined time period according to whether a data variation of the sensed information received within the predetermined time period exceeds a preset error value; and
a state control module for controlling a portion of the sensors to enter into a sleeping state or a low-power consumption state when the electronic device is under the stationary state within the predetermined time period.

8. The sensor management system according to claim 7, further comprising:
a sampling rate setting module for reducing a sampling rate of the sensors not entered into the sleeping state when the electronic device is under the stationary state within the predetermined time period.

9. The sensor management system according to claim 8, further comprising:
an interrupt signal receiving module for receiving an interrupt signal from the sensor not entered into the sleeping state; and
an activating module for restoring the sensors entered into the sleeping state or the low-power consumption state to a normal state, and restoring the sampling rate of the sensors which sampling rate was reduced.

10. The sensor management system according to claim 8, further comprising:
a calculating module for generating predicted sensed information using the sensed information when the receiving module receives the sensed information from the sensor not entered into the sleeping state after the sampling rate is reduced.

11. The sensor management system according to claim 10, wherein the sensors further comprises a sensor hub.
